(19) United States
(12) Patent Application Publication
(10) Pub. No.: US 2002/0006514 A1
(43) Pub. Date: Jan. 17, 2002

(54) Carbamate functional polymers and coatings thereof

(76) Inventors: Dean C. Webster, Kingsport, TN (US); Allen L. Crain, Kingsport, TN (US)

Correspondence Address: MORGAN, LEWIS & BOCKIUS, 1800 M STREET NW, WASHINGTON, DC, 20036-5869, US

(21) Appl. No.: 09/742,333

(22) Filed: Dec. 22, 2000

Related U.S. Application Data
(60) Provisional application No. 60/173,556, filed on Dec. 30, 1999.

(51) Int. Cl. B32B 27/36; C08F 263/02

(52) U.S. Cl. 428/412; 428/423.1; 428/424.2; 525/277; 525/330.9; 525/331.1; 427/372.2

(57) ABSTRACT

This invention involves a composition composed of a homopolymer of vinyl ethylene carbonate or a copolymer of vinyl ethylene carbonate, which is further reacted with ammonia, a primary alkyl amine, or an amino alcohol. The resulting compound, which is a polymer containing both carbamate and hydroxyl groups is then mixed with an aminoplast, coated on a substrate and cured to form a crosslinked coating. In addition, the polymer containing both hydroxyl and carbamate functional groups can be further reacted with either an anhydride or a monofunctional isocyanate, resulting in a copolymer containing only carbamate functional groups. This copolymer is mixed with an aminoplast, coated on a substrate and cured to form a crosslinked coating.

### RELATED APPLICATIONS

This application claims the benefit of provisional application, Ser. No. 60/173,556 filed Dec. 30, 1999, the disclosure thereof being incorporated herein in its entirety.

### BACKGROUND OF THE INVENTION

Polymers containing 5-membered cyclic carbonate functional groups can be obtained via a number of methods. A recent review (Polymer News, 23(6), 187-192 (1998)) summarizes many of the methods that have been explored for the synthesis of polymers and oligomers bearing cyclic carbonate functionality.

Seisan Kenkyu, 25 (7), (1973), describes the synthesis of the homopolymer of vinyl ethylene carbonate and copolymers of vinyl ethylene carbonate with styrene, vinyl acetate, and maleic anhydride. This article also describes the reaction of a vinyl ethylene carbonate homopolymer and a vinyl ethylene carbonate-styrene copolymer with butyl amine A vinyl ethylene carbonate-styrene copolymer was reacted with aminoethanol. The reaction with aminoethanol did not go to completion; a substantial amount of cyclic carbonate groups were left in the polymer. No further reactions or crosslinking were done with the resulting products.

Plasticheskie Massy, No. 2, 1996, 19-22 describes copolymerization of vinyl ethylene carbonate with methyl methacrylate, ethyl acrylate, and styrene. Yields of the copolymers was low and decreased as the level of vinyl ethylene carbonate was increased. The highest level of vinyl ethylene carbonate incorporated into a copolymer was 31.98 mole percent.

U.S. Pat. No. 5,567,527 describes the formation of coatings by copolymerization of vinyl ethylene carbonate with other comonomers and then crosslinking with multifunctional primary amines.

Cyclic carbonate functional acrylic copolymers can be prepared from the copolymerization acrylate and methacrylate esters of glycerin carbonate with other unsaturated monomers and are described for example in U.S. Pat. No. 2,979,514.

Carbamate functional oligomers and polymers are also described in the patent literature. For example, U.S. Pat. No. 5,336,566 describes the formation of carbamate functional polyurethane by reacting hydroxypropyl carbamate with a polyfunctional isocyanate. In this example, the carbamate moiety is formed first, then combined with the polyfunctional isocyanate to form the carbamate functional oligomer.

U.S. Pat. Nos. 5,726,246 and 5,356,669 disclose the preparation of a carbamate functional acrylic polymer by reaction of an isocyanate functional acrylic polymer with hydroxy propyl carbamate. The carbamate functional acrylic polymer is then crosslinked with a melamine-formaldehyde resin to yield a thermosetting coating.

EP 710,676 discloses the formation of a carbamate functional acrylic copolymer by the copolymerization of an unsaturated monomer containing carbamate functionality with other acrylate and methacrylate monomers.

EP 710,676 also discloses the formation of a carbamate functional acrylic copolymer by first forming a cyclic carbonate functional copolymer, then reacting the cyclic carbonate groups with ammonia gas to form a beta hydroxy carbamate. The cyclic carbonate functional copolymer is prepared by the free radical copolymerization of “methacrylate carbonate” with other monomers.

### BRIEF DESCRIPTION OF THE DRAWINGS

FIG. 1 depicts the reaction of a cyclic carbonate functional polymer with ammonia to form a hydroxy-carbamate functional polymer. Possible subsequent reactions with the hydroxyl group of the polymer are also shown.

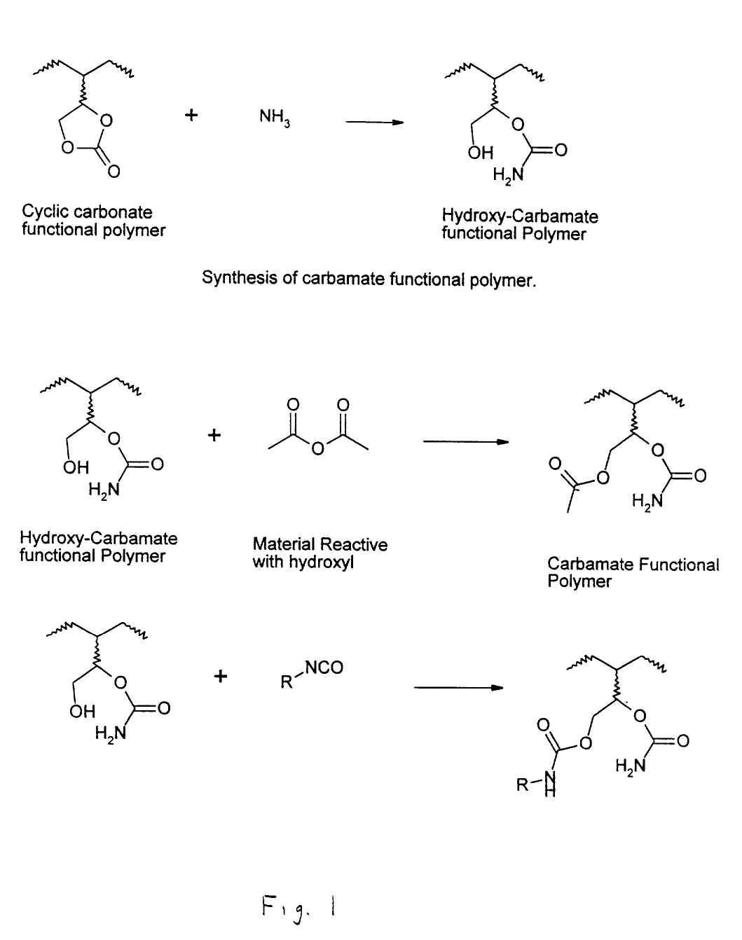

### SUMMARY OF THE INVENTION

This invention involves a composition composed of a homopolymer of vinyl ethylene carbonate or a copolymer of vinyl ethylene carbonate, which is further reacted with ammonia, a primary alkyl amine, or an amino alcohol. The resulting compound, which is a polymer containing both carbamate and hydroxyl groups is then mixed with an aminoplast, coated on a substrate and cured to form a crosslinked coating.

In addition, the polymer containing both hydroxyl and carbamate functional groups can be further reacted with either an anhydride or a monofunctional isocyanate, resulting in a copolymer containing only carbamate functional groups. This copolymer is mixed with an aminoplast, coated on a substrate and cured to form a crosslinked coating.

### DETAILED DESCRIPTION

This invention involves the formation of a carbamate functional copolymer by the homopolymerization or copolymerization of vinyl ethylene carbonate with other comonomers, followed by the reaction of the cyclic carbonate polymer with ammonia, ammonium hydroxide, a primary amine or a secondary amine. Optionally, the hydroxyl group formed can be capped by reacting with any compound reactive with hydroxyl groups. The carbamate functional polymer is mixed with an aminoplast, applied to a substrate and crosslinked to form a coating.

Vinyl ethylene carbonate is an ethylenically unsaturated monomer capable of undergoing free radical homo- and copolymerization when contacted with a free radical initiator. Homopolymerization can be carried out using any commonly used methods of free radical polymerization, bulk, solution, suspension, or emulsion. Initiation of free radical polymerization can be accomplished using any commonly used method; either thermal, redox, or photoinitiation.

Vinyl ethylene carbonate can be copolymerized with other ethylenically unsaturated monomers. Preferred monomers include the following:

(1) acrylic, methacrylic, crotonic or other unsaturated acids or their esters such as methyl methacrylate, ethyl acrylate, butyl acrylate, propyl acrylate, butyl methacrylate, 2-ethyl hexyl acrylate, 2-ethyl hexyl methacrylate, cyclohexyl acrylate, cyclohexyl methacrylate, dimethyl amino ethyl methacrylate, hydroxyl ethyl methacrylate, hydroxy ethyl acrylate, glycidyl methacrylate, and the like;

(2) styrene-type monomers such as styrene, alpha methyl styrene, vinyl toluene, m-isopropenyl -α,α-dimethylbenzyl isocyanate, and the like;

(3) vinyl compounds such as vinyl chloride, vinyl acetate, vinyl propanoate, vinyl butyrate, vinyl 2-ethyl hexanoate, vinyl pivalate, vinyl neononanoate, vinyl neodecanoate, vinyl neoundecanoate, and the like;

(4) allyl compounds such as allyl alcohol, allyl acetate, allyl chloride, and the like;

(5) esters of maleic and/or fumaric acid such as dimethyl maleate, dimethyl fumarate, diethyl maleate, diethyl fumarate, dioctyl maleate, dioctyl fumarate and the like;

(6) other copolymerizable ethylenically unsaturated monomers such as maleic anhydride, itaconic anhydride, n-methyl maleimide, acrylonitrile, acrylamide, isoprene, ethylene, butadiene, and the like.

Especially preferred unsaturated monomers include the esters of methacrylic and/or acrylic acid and esters of vinyl alcohol. Most preferred are esters of vinyl alcohol, especially the branched esters such as vinyl pivalate, vinyl neononanoate, vinyl 2-ethyl hexanoate, and vinyl neodecanoate.

The choice of free radical initiator depends on the reaction conditions desired for the copolymerization. The polymerization can be initiated by conventional free radical initiators such as benzoyl peroxide, di-t-butyl peroxide, t-butyl peroctoate, t-amyl peroxy-2-ethyl hexanoate, t-butyl peroxy-2-ethyl hexanoate, hydrogen peroxide, dicumyl peroxide, t-butyl hydroperoxide, potassium or ammonium peroxydisulfate, 2,2′-azobis(2-methylpropanenitrile), 2,2′-azobis(2-methylbutanenitrile), etc. Redox initiation can be carried out in any usual manner using for example persulfate/metabisulfite, hydrogen peroxide/sodium formaldehyde sulfoxylate, t-butyl hydrogen peroxide/sodium formaldehyde sulfoxylate, etc. Most preferred are those initiators which impart little color to the formed homopolymer or copolymer.

The solution polymerizations are carried out in a solvent appropriate for the monomers used, the desired end-use of the polymer, and the polymerization conditions. Solvents can include xylene, toluene, methyl amyl ketone, methyl isobutyl ketone, acetone, ethyl ethoxy propionate, ethylene glycol butyl ether, propylene glycol monomethyl ether, propylene glycol monomethyl ether acetate, and the like. Preferred solvents are those which dissolve both the monomers and the polymer that is produced.

Upon completion of the polymerization it is preferred that any unreacted monomers be removed from the polymer that has been synthesized. This can be accomplished using a number of different methods. One method includes precipitation of the polymer solution in a non-solvent for the polymer which is a solvent for any unreacted monomers. The precipitated polymer is filtered and dried. The resulting dried polymer powder can then be redissolved in the solvent of choice, if desired.

Another method for removing unreacted monomer is to remove the unreacted monomers as a vapor using reduced pressure, heat, or a combination of the two.

If the polymerization conditions and monomer composition are such that little or an acceptable amount of unreacted monomer is formed, the above step of removing the unreacted monomer is not necessary and can be eliminated.

After the polymer containing cyclic carbonate functional groups is formed and purified, it is subjected to reaction with ammonia, ammonium hydroxide, a primary amine, a primary amino alcohol, secondary amine, or combinations thereof. This reaction results in the formation of a carbamate functional polymer. This reaction is carried out in a solvent or solvent combination that solubilizes both the cyclic carbonate functional resin and the carbamate functional resin that is produced. The reaction is conduced at a temperature that permits the reaction to proceed at a reasonable rate. Preferred temperatures are in the range of 10° C. to 150° C. Examples of primary amines include butylamine, 2-ethyl hexyl amine, propylamine, methylamine, etc. Amino alcohols can include aminoethanol, 3-aminopropanol, etc. Cyclic secondary amines can include piperidine, morpholine, N-methylpiperazine, etc.

Optionally, the resin containing beta-hydroxy carbamate groups can be further reacted with a compound that reacts with the hydroxyl groups. The compound may be a monofunctional compound or have other functional groups and be used to introduce the other functionality into the polymer. Use of a monofunctional compound that reacts with the hydroxyl group yields a polymer containing only carbamate functionality. The mononofunctional compound can be an acid or anhydride, resulting in an ester group. Or the compound can be a monofunctional isocyanate, resulting in a urethane group. Examples of multifunctional compounds that may de used to introduce other functionality include, but are not limited to, unsaturated carboxylic acids, acid anhydrides, silyl esters, bis-isocyanates.

The carbamate functional polymer is mixed with an aminoplast resin to form a mixture that can be applied to a substrate and cured to form a coating. The aminoplast resin can be any etherified and alkylated resin derived from melamine or urea.

In the following examples, a number of materials are identified by abbreviations or trade names. These are identified as follows:

VeoVa-9 is vinyl neononanoate from Shell Chemical Company.

Lupersol-575 is t-amylperoxy 2-ethyl hexanoate from Elf Atochem Organic Peroxides Division.

Resimene 745 (R745) is a hexamethoxymethyl melamine resin supplied by Monsanto Corporation, now known as Solutia, Inc.

FC-430 is a fluorocarbon flow aid from 3M.

Polymers and coatings are characterized using the following methods:

Molecular weight

Molecular weight of the polymers was determined by gel permeation chromatography. Molecular weights are determined relative to polystyrene standards.

Fourier Transform Infrared Spectroscopy

Fourier Transform Infrared Spectroscopy is used to follow the reaction of the cyclic carbonate with the amine. Samples were coated onto zinc selenide crystals and a FTIR spectrum measured.

Methyl Ethyl Ketone Resistance

Cured films were rubbed with a methyl ethyl ketone saturated cloth according to ASTM D-5402. Results are reported as the number of double rubs required for breakthrough of the film to the substrate. Test is terminated after 300 MEK double rubs. A rating of >300 indicates that the film was not marred.

Pencil Hardness

Pencil hardness was measured using a series of pencils containing leads of differing hardness according to ASTM D-3363. The hardness is reported as the hardest pencil lead that does not penetrate the coating film.

Konig Pendulum Hardness

The Konig pendulum hardness (KPH) is determined using a Byk-Gardner pendulum hardness tester according to ASTM D-4366. Hardness is reported as the number of seconds required for the pendulum swing to be damped from a 6° swing to a 3° swing.

Impact Resistance

Forward and reverse impact resistance is determined using a falling dart impact tester according to ASTM D-2794. Results are reported as the maximum in-lbs of force where the film remains intact.

### EXAMPLES

### Example 1.

Synthesis of vinyl ethylene carbonate copolymer.

A one-liter two-piece resin kettle equipped with a heating mantle, mechanical stirrer, thermocouple, nitrogen inlet, and condenser was charged with 315 g of propylene glycol monomethyl ether (PM). With stirring, the solvent was heated to 80° C. In a separate container, 222.3 g vinyl ethylene carbonate, 362.7 g VeoVa-9 and 23.4 g Lupersol-575 are mixed. The monomer mixture was added to the heated solvent at a rate of 2.03 g/min. One hour after the addition is complete, 2.0 g of Lupersol-575 was added. After an additional one-hour hold, the mixture was cooled and poured out. The resin solution was clear and colorless and had a solids content of 63.23%. The number average molecular weight (Mn) by gel permeation chromatography was 1220 and the weight average molecular weight (Mw) was 1770.

### Example 2.

Synthesis of vinyl ethylene carbonate copolymer.

A one-liter two-piece resin kettle equipped with a heating mantle, mechanical stirrer, thermocouple, nitrogen inlet, and condenser was charged with 315 g of mixed xylenes and 292.5 g vinyl ethylene carbonate. With stirring, the mixture was heated to 80° C. In a separate container, 175.5 g butyl acrylate, 117.0 g 2-ethyl hexyl acrylate, and 23.4 g Lupersol-575 are mixed. The monomer mixture was added to the heated solvent at a rate of 2.03 g/min. One hour after the addition was complete, 2.0 g of Lupersol-575 was added. After an additional one-hour hold, the mixture was cooled and poured out. The resin solution was clear and colorless and had a solids content of 57.40%. The Mn by gel permeation chromatograpy was 1140 and the Mw was 2280. The resin was placed in the feed vessel of a wiped film distillation unit. Temperature of the heated jacked was set at 130° and the vacuum system was set at 10 torr. The resin was slowly fed to the unit to strip the unreacted monomers and solvent. After stripping the solids content of the resin was 97.2%. The resin was redissolved in mixed xylenes to a solids content of 65%.

### Example 3.

Homopolymerization of VEC.

226.0 g propylene carbonate was weighed out into a 500 mL reactor kettle and heated to 80° C. Vinyl ethylene carbonate (419.7 g) and Lupersol-575 (21.0 g) was weighed out into a 500 mL Erlenmeyer flask and added to the reactor over 3 hours. Temperature held at 80° C. for 1 hour, then 0.5 g Lupersol-575 was added. Temperature held at 80° C. for an additional 1.5 hours before cooling to room temperature. Polymer was precipitated in acetone, filtered, washed with acetone followed by a methanol wash. Material was dried in a vacuum oven at 70° C. overnight. Polymer had a Mn of 5,801 and a Mw of 10,332.

### Example 4.

Synthesis of hydroxy carbamate functional polymer.

Into a 500 mL, 3-neck round bottom flask equipped with a mechanical stirrer, thermocouple, heating mantle and condenser was placed 102.32g of the VEC/VV9 copolymer solution from Example 1. Resin was heated to 75° C. To this was added 306 ml of a 8M ammonia hydroxide solution (11X excess) in approximately 15 minutes and stirred overnight. The aqueous layer was decanted, then the polymer was concentrated using a rotary evaporator at 60° C. and 25 mm Hg. Redissolved in isopropanol to make a 67.1 % solids solution. Infrared spectroscopy (IR) showed only a very slight amount of unreacted carbonate present and the formation of urethane indicating that the reaction had occurred.

### Example 5.

Synthesis of substituted hydroxy carbamate functional polymer.

Into a 300 mL, 3-neck round bottom flask equipped with a mechanical stirrer, thermocouple, heating mantle and condenser was placed 112.15 g of the VEC/VV9 copolymer solution from Example 1. Butylamine (26.60 g, 0.364 mol) was added to the reaction with stirring in one portion. Reaction was heated to 80° C. and maintained overnight. Polymer was concentrated by rotary evaporator at 50° C. and 225 mm Hg to remove the unreacted amine. IR showed only a very slight amount of unreacted carbonate present and the formation of urethane indicating substantial reaction of the cyclic carbonate.

### Example 6.

Synthesis of dihydroxy carbamate functional polymer.

Into a 250 mL, 3-neck round bottom flask equipped with a mechanical stirrer, condenser, thermocouple, heating mantle and addition funnel was placed 80.03 g of the VEC/VV9 copolymer solution from Example 1. Aminopropanol (17.76 g, 0.24 mol) was added in one portion. Reaction was heated to 80° C. and maintained for 5 hours. Polymer was concentrated by rotary evaporator at 50° C. and 225 mm Hg to remove unreacted amine. IR showed only a very slight amount of unreacted carbonate present and the formation of urethane indicating substantial reaction of the cyclic carbonate.

### Example 7.

Synthesis of hydroxy carbamate functional polymer.

Into a 100 mL, 3-neck round bottom flask equipped with a magnetic stirrer, thermocouple, heating mantle and condenser was placed 77 g of a VEC acrylic copolymer solution similar to Example 2. Polymer was heated to 40° C. for better stirring and 10 ml methanol was added. Ammonia gas was bubbled into resin over 3 days until IR showed that the carbonate was substantially reacted. Reaction was cooled to room temperature. Placed polymer on rotary evaporator at 40° C. and 225 mm Hg to remove the excess ammonia. IR showed only a very slight amount of unreacted carbonate present and the formation of urethane indicating substantial reaction of the cyclic carbonate.

### Example 8.

Synthesis of subsituted hydroxy carbamate functional polymer.

Into a 100 mL, 3-neck round bottom flask equipped with a magnetic stirrer, thermocouple, heating mantle, nitrogen inlet, and a condenser was placed 35 g of the VEC acrylic copolymer solution from Example 2. To this was added butylamine (9.14 g, 0.125mol). Reaction was heated to 80° C. and maintained overnight with stirring. Placed on rotary evaporator at 45° C. and 15 mm Hg to remove the excess amine. IR showed only a very slight amount of unreacted carbonate present and the formation of urethane indicating substantial reaction of the cyclic carbonate.

### Example 9.

Synthesis of dihydroxy carbamate functional polymer.

Into a 100 mL, 3-neck round bottom flask equipped with a magnetic stirrer, thermocouple, heating mantle, nitrogen inlet, and condenser was placed 35 g of the VEC acrylic copolymer solution from Example 2. To this was added aminopropanol (9.43 g, 0.125 mol). Reaction was heated to 80° C. and maintained overnight with stirring. Placed on rotary evaporator at 60° C. and 15 mm Hg to remove the excess amine. IR showed only a very slight amount of unreacted carbonate present and the formation of urethane indicating substantial reaction of the cyclic carbonate. IR showed only a very slight amount of unreacted carbonate present and the formation of urethane indicating substantial reaction of the cyclic carbonate.

### Example 10.

Synthesis of hydroxy carbamate functional polymer.

Into a 100 mL, 3-neck round bottom flask equipped with a magnetic stirrer, condenser, thermocouple, heating mantle and nitrogen inlet was placed 70.04 g of a 40% VEC homopolymer solution (Example 3) in N,N-dimethylacetamide. 10 mL methanol was added to the reaction. Bubbled ammonia into the reaction for 8 hours. Placed reaction on rotary evaporator at 40° C. and 15 mm Hg to remove the excess ammonia. IR showed only a very slight amount of unreacted carbonate present and the formation of urethane indicating substantial reaction of the cyclic carbonate.

### Example 11.

Synthesis of substituted hydroxy carbamate functional polymer.

Into a 100 mL, 3 -neck round bottom flask equipped with a magnetic stirrer, condenser, addition funnel, heating mantle, thermocouple and nitrogen inlet was placed 70.33 g of a 40% VEC homopolymer (Example 3) solution in N,N-dimethylacetamide. Heated to 80° C., then 5 mL of methanol was added. Began adding butylamine (20.48 g, 0.28 mol) in portions. Maintained 80° C. overnight with stirring. Placed to rotary evaporator at 60° C. and 15 mm Hg to remove the excess amine and solvent. IR showed only a very slight amount of unreacted carbonate present and the formation of urethane indicating substantial reaction of the cyclic carbonate.

### Example 12.

Synthesis of dihydroxy carbamate functional polymer.

Into a 100 mL, 3-neck round bottom flask equipped with a magnetic stirrer, condenser, addition funnel, heating mantle, thermocouple and nitrogen inlet was placed 35.73 g of 40% VEC homopolymer (Example 3) solution in N,N-dimethylacetamide. Heated to 80° C. and added 5 mL methanol. Began adding aminopropanol (12.02 g, 0.16 mol) in portions. Maintained 80° C. overnight with stirring. Placed on rotary evaporator at 65° C. and 15 mm Hg to remove the excess amine and solvent. IR showed only a very slight amount of unreacted carbonate present and the formation of urethane indicating substantial reaction of the cyclic carbonate.

### Example 13.

Coating formulation from Examples 4-12.

Coatings were formulated from the resins synthesized in examples 4 through 12. As an example procedure, 12.03 g of the polymer from Example 5 was combined with 5.14 g Resimene 745. To this was added 9.00 g solvent blend composed of 55% mixed xylenes, 32% methyl amyl ketone, 6.5% ethyl 3-ethoxypropionate and 6.5% n-butanol. 0.25 g of a 30% FC-430 solution in methyl amyl ketone added to the formulation and the formulation was shaken for one hour. Then 0.17 g of a 30% p-toluene sulfonic acid (pTSA) solution in isopropanol was added just prior to the preparation of the coatings. Coatings were drawn down on Bonderite 1000 panels and baked in an oven at 160° C. for 45 minutes. Resins from examples 4 through 12 were formulated into coatings as indicated in Table 1. Results of the solvent resistance test (MEK double rubs) indicate that the coatings were cured.

TABLE 1
Coatings formulations

| Formulation | A | B | C | D | E | F | G | H |
|---|---|---|---|---|---|---|---|---|
| Resin | 4 | 5 | 6 | 7 | 8 | 9 | 11 | 12 |
| Example | | | | | | | | |
| Resin | 14.92 | 12.03 | 12.01 | 3.81 | 22.76 | 28.07 | 31.7 | 23.4 |
| R745 | 4.32 | 5.14 | 5.13 | 1.66 | 9.75 | 12.03 | 13.59 | 10.03 |
| Solvent | 2.64 | 9 | 5.47 | 2.91 | 17.63 | 21.74 | 24.56 | 18.12 |
| blend | | | | | | | | |
| pTSA | 0.17 | 0.17 | 0.18 | 0.06 | 0.33 | 0.4 | 0.45 | 0.33 |
| FC430 | 0.19 | 0.25 | 0.25 | 0.07 | 0.43 | 0.53 | 0.6 | 0.45 |
| Pencil | 5H | 4H | 5H | 6H | 7H | >9H | 7H | 8H |
| Hardness | | | | | | | | |
| KPH(sec) | 202 | 185 | 167 | 170 | 161 | 132 | 176 | 105 |
| MEK Dbl | >300 | >300 | >300 | >300 | >300 | >300 | >300 | 300 |
| Rubs | | | | | | | | |

### Example 14.

Reaction of hydroxyl carbamate functional polymer.

The following procedure was used to react the hydroxyl group of the hydroxyl carbamate functional polymer with an ester, yielding a polymer with only carbamate functionality. Into a 100 ml, 3-necked, round bottom flask equipped with a magnetic stirrer, condenser, thermocouple, nitrogen inlet and heating mantle was placed 9.0 g of the VEC acrylic carbamate from Example 7. Acetic anhydride (13.05 g, 0.13 mol) and 3.01 g acetone was added. Reaction was heated to 50° C. and maintained overnight. Reaction extracted twice with water to hydrolyze the excess anhydride and remove the acetic acid formed during the reaction. Polymer redissolved in acetone and placed on rotary evaporator at 45C and 13 mm Hg.

### Example 15.

Reaction of hydroxyl carbamate functional polymer.

The following procedure was used to react the hydroxyl group of the hydroxyl carbamate functional polymer with a urethane yielding a polymer with only carbamate functionality. Into a 100 ml, 3-necked, round bottom flask equipped with a magnetic stirrer, condenser, thermocouple, nitrogen inlet and heating mantle was placed 40.0 g of the VEC/VV9 carbamate resin from Example 4. Resin was heated to 55° C. and cyclohexyisocyanate (21.0 g) was added in portions and stirred overnight. Resin was concentrated by rotary evaporator at 50° C. and 25 mm Hg.

### Example 16.

Coatings formulation from Examples 14 and 15.

Clear coatings were prepared as described in Example 13 using the carbamate functional polymers described in examples 14 and 15. The formulations and coatings properties are listed in Table 2. The coatings were hard and had good solvent resistance indicating curing of the carbamate functional polymers.

TABLE 2
Coatings formulations and properties.

| Formulation | A | B |
|---|---|---|
| Resin Example | 13 | 14 |
| Resin | 3.69 | 3.78 |
| R745 | 1.62 | 1.67 |
| Solvent blend | 2.89 | 2.96 |
| pTSA | 0.06 | 0.06 |
| FC430 | 0.07 | 0.08 |
| Isopropanol | 0.66 | 0.68 |
| Pencil Hardness | 5H | 3H |
| KPH (sec) | 162 | 144 |
| MEK Dbl Rubs | >300 | >300 |
| Impact, in-lbs | | |
| (Forward/Reverse) | 24/<6 | 20/<6 |

The claimed invention is:

1. A curable coating composition composed of
a) a homopolymer of vinyl ethylene carbonate or a copolymer of vinyl ethylene carbonate with other ethylenically unsaturated monomers, reacted with ammonia, ammonium hydroxide, a primary amine, a cyclic secondary amine, an amino alcohol, or mixtures thereof; and
b) an aminoplast.

2. A curable coating composition of claim 1, wherein the homoplymer or copolymer a) is further reacted with a compound reactive with hydroxyl groups.

3. A method of coating a substrate consisting of applying a curable composition of claim 1 on a substrate and curing the coating on the substrate.
